(19) United States
(12) Patent Application Publication
(10) Pub. No.: US 2009/0202967 A1
(43) Pub. Date: Aug. 13, 2009

(54) COMPUTER-BASED EVALUATION TOOL FOR ORGANIZING AND DISPLAYING RESULTS OF DATASET ANALYSIS

(76) Inventors: Carol Fitzgerald, Scarsdale, NY (US); Brendan Light, Brooklyn, NY (US)

Correspondence Address: rudoler & derosa llc;ATTN: DOCKET CLERK, 2 BALA PLAZA,, SUITE 300, BALA CYNWYD, PA, 19004, US

(21) Appl. No.: 12/030,496

(22) Filed: Feb. 13, 2008

(51) Int. Cl. G09B 7/00

(52) U.S. Cl. 434/322

(57) ABSTRACT

A study that has a set of questions asked of a number of respondents and a set of corresponding answers. An evaluation tool evaluates every answer to a selected question to identify key terms therein, and develops a corresponding key term cloud based on the identified key terms of the selected question. The cloud is a visual representation of the identified key terms such that each key term appears in the cloud in a relative manner based on an attribute of the key term with regard to the answers. The tool displays the developed cloud for the selected question with the answers for the selected question, and a study evaluator views the relatively appearing key terms in the displayed cloud. Based thereon, the evaluator discerns trends in the answers to the selected question.

### FIELD

The present disclosure is directed to an on-screen evaluation tool for a computing device that organizes and displays the results from a dataset such as a plurality of interviews and that allows a user of the viewer to more readily evaluate the displayed results. More particularly, the present disclosure is directed to such an evaluation tool that displays index terms such as keywords culled from the interviews according to the frequency of use of such keywords across the interviews, and that allows the user to select from among displayed keywords of interest to display corresponding interview responses that reference such selected keywords.

### BACKGROUND

Consumer studies and other similar types of studies are a well-known method of developing a body of data or dataset based on responses collected from consumers or the like in response to specific questions. Such studies may be performed for a wide variety of purposes. For example, a study may be performed to develop a product or service (hereinafter, ‘product’), develop packaging for a product, develop a marketing campaign for a product, or the like. Similarly, such a study may be performed to evaluate a developed product, package, marketing campaign, etc. Likewise, such a study may be performed to judge public attitudes regarding product- and non-product-related issues, such as for example political issues, media issues, issues of general interest, and the like.

As is known, there are a wide variety of techniques for conducting such studies that are well known within the marketing and public surveying communities. One particular method of conducting such a study is a survey in which a plurality of respondents are identified and each respondent is interviewed. In such a study interview, each respondent is asked questions from a set of questions, and the answer to each asked question is collected and entered into a database of answers, either verbatim or possibly with modifications as judged appropriate and/or necessary. Such study interviews can be conducted in person, via telephone, by mail, or through computer such as by way of an online survey or an email questionnaire. Such a question-based survey by its nature tends to be highly formatted in that the answers are usually restricted to a predetermined set of allowable response, such as yes or no, or multiple choice. Thus, it is relatively easy to aggregate the allowable responses of multiple respondents as resident in the database so that a wide variety of objective analytical and statistical reports can be generated therefrom.

However, a study such as a highly formatted question-based survey has an inherent limitation in that the restricted responses are usually logical and sequential in their construct as well as text-based in their prompts. Additional, such a survey is susceptible to being inherently biased, especially if the restricted responses are not neutrally constructed. Also, such a survey may not generate forthright and sincere answers from respondents, for example if the survey is viewed by each respondent as a test such that the respondent is compelled to ‘pass’ the test by providing the ‘right’ answers, and not necessarily honest answers.

Thus, it is at least some times more desirable to conduct a question-based survey that is not highly formatted, where the answers are not restricted to a predetermined set of allowable responses but instead can be open-ended or non-restricted responses. Typically, although by no means exclusively, the non-restricted responses are textual in nature and thus can be entered into a database in such a textual form. As may be appreciated, the benefit obtained from such textual non-restricted responses is that such response tends to elicit richer, more personal, and more emotional answers from consumers as compared with restricted responses. Additionally, textual non-restricted responses provide opportunities to delve into subconscious attitudes that respondents would not otherwise reveal based on restricted responses.

However, and as should be understood, the non-restricted responses from such a survey as a dataset are not relatively easy to aggregate, especially in any objective manner, so that quantitative analytical and statistical reports can be generated therefrom. Instead, a survey evaluator heretofore performed a more qualitative evaluation of such non-restricted responses/dataset, which of course provides opportunity for the survey evaluator to impart his or her own bias. At any rate, such an evaluation tends to be subjective and therefore of limited use. Additionally, the responses do not necessarily follow established grammar or idiomatic forms, and therefore can be difficult to read.

Accordingly, a need exists for a computer-based evaluation tool for organizing and displaying non-restricted textual and also non-textual data in a dataset. In particular, a need exists for a computer-based evaluation tool for organizing and displaying non-restricted textual and also non-textual responses from questions presented during a study interview. Further, a need exists for such an evaluation tool that displays keywords or other index terms culled from the interviews/dataset to an evaluator in a manner that allows the evaluator to select from among displayed keywords/index terms of interest to display corresponding interviews/data from the dataset that reference such selected keywords/index terms. Thus, the evaluation can be performed by the evaluator in a more objective manner.

### SUMMARY

The aforementioned needs are satisfied at least in part by a method and system with regard to a study that has a set of questions asked of a number of respondents and a set of corresponding answers, where each question has a corresponding answer from each respondent. The method is performed by an evaluation tool that is instantiated on a computing device.

The evaluation tool evaluates every answer to a selected question to identify key terms therein, and develops a corresponding key term cloud based on the identified key terms of the selected question. The cloud is a visual representation of the identified key terms such that each key term appears in the cloud in a relative manner based on an attribute of the key term with regard to the answers. The tool displays the developed cloud for the selected question with the answers for the selected question, and a study evaluator can view the relatively appearing key terms in the displayed cloud. Based thereon, the evaluator can discern trends in the answers to the selected question.

### BRIEF DESCRIPTION OF THE DRAWINGS

The foregoing summary, as well as the following detailed description of various embodiments of the present invention, will be better understood when read in conjunction with the appended drawings. For the purpose of illustrating the embodiments, there are shown in the drawings embodiments which are presently preferred. As should be understood, however, the embodiments of the present invention are not limited to the precise arrangements and instrumentalities shown. In the drawings:

FIG. 1 is a block diagram of an example of a computing environment within which various embodiments of the present invention may be implemented;

FIG. 2 is a block diagram of an evaluation tool instantiated on a computing device and accessing questions and answers in a database to generate a keyword cloud from keywords found in the answers to a particular question in accordance with various embodiments of the present invention;

FIG. 3 is a screen shot displayed at least initially by the tool of FIG. 2 in accordance with various embodiments of the present invention;

FIG. 4 is a flow diagram showing key steps performed with regard to the tool of FIG. 2 in accordance with various embodiments of the present invention;

FIG. 5 is a screen shot displayed by the tool of FIG. 2 when a study evaluator selects a keyword from the displayed keyword cloud of FIG. 3 in accordance with various embodiments of the present invention;

FIG. 6 is a screen shot displayed by the tool of FIG. 2 when a study evaluator selects two keywords from the displayed keyword cloud of FIG. 3 in accordance with various embodiments of the present invention;

FIG. 7 is a screen shot displayed by the tool of FIG. 2 when a study evaluator performs a word search on the answers of FIG. 3 in accordance with various embodiments of the present invention; and

FIG. 8 is a screen shot displayed by the tool of FIG. 2 when a study evaluator selects that the displayed cloud comprise multi-word keyphrases in accordance with various embodiments of the present invention;

### DETAILED DESCRIPTION

### Example Computing Environment

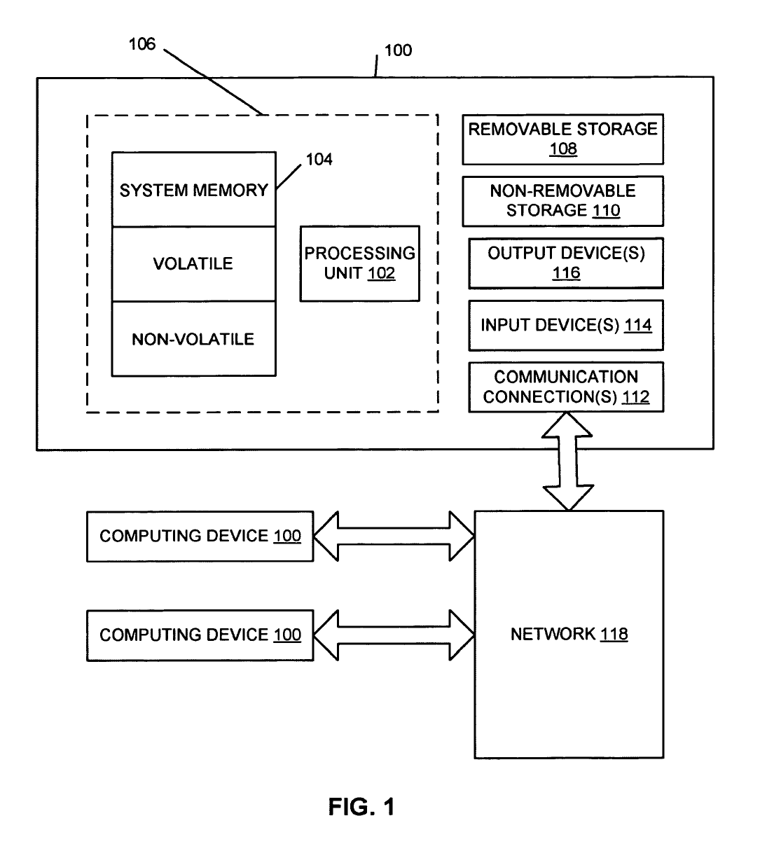

FIG. 1 is set forth herein as an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well known computing systems, environments, and/or configurations that may be suitable for use include, but are not limited to, personal computers (PCs), server computers, handheld or laptop devices, multi-processor systems, microprocessorbased systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

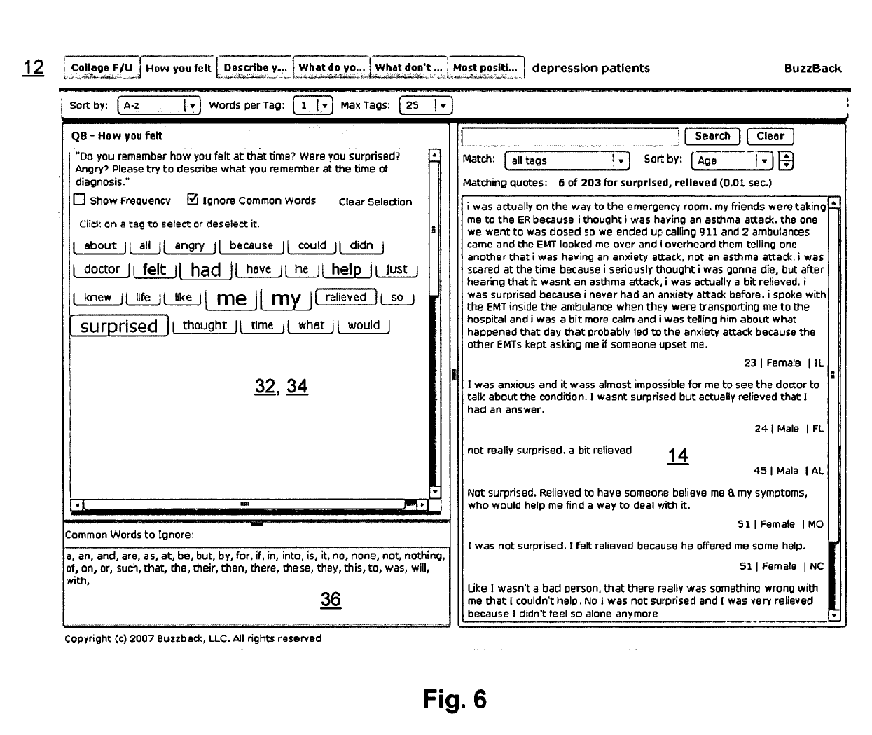

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 6 by removable storage 108 and non-removable storage 110.

Computing device 100 typically includes or is provided with a variety of computer-readable media. Computer readable media can be any available media that can be accessed by computing device 100 and includes both volatile and non-volatile media, removable and non-removable media. By way of example, and not limitation, computer readable media may comprise computer storage media and communication media.

Computer storage media includes volatile and non-volatile, removable and non-removable media implemented in any method or technology for storage of information such as computer readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

### Study/Dataset

In connection with various embodiments of the present invention, a study is performed for a particular purpose which may be any purpose without departing from the spirit and scope of the present invention. For example, and as was set forth above, a study may be performed to develop a product or service (hereinafter, ‘product’), develop packaging for a product, develop a marketing campaign for a product, or the like. Similarly, such a study may be performed to evaluate a developed product, package, marketing campaign, etc. Likewise, such a study may be performed to judge public attitudes regarding product- and non-product-related issues, such as for example political issues, media issues, issues of general interest, and the like.

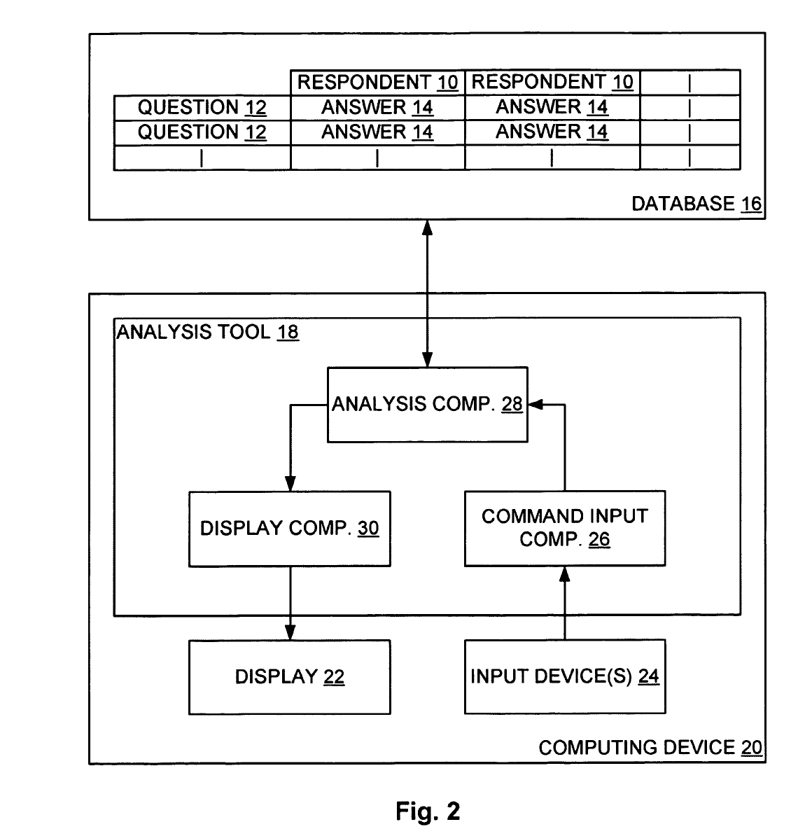

Regardless of the purpose of the study, in various embodiments of the present invention, and referring now to FIG. 2, a plurality of respondents 10 are identified and each respondent 10 is interviewed. Such identifying of respondents 10 may be performed in any appropriate manner without departing from the spirit and scope of the present invention. For example, the respondents 10 may be randomly selected at some public location, or may be narrowed according to predefined criteria and than invited to participate in the study.

The study interview can be conducted in any appropriate manner, such as in person, via telephone, by mail, or through computer such as by way of an online survey or an email questionnaire. Nevertheless, it is presumed that in the study interview, each respondent 10 is asked questions 12 from a set of questions 12, and the answer 14 to each asked question 12 of the respondent 10 is collected and entered into a database 16 of answers 14 in an appropriate form. Notably, each answer 14 of the respondent is expected to be textual in nature, and thus can be entered into the database in a word format. Also notably, each answer 14 is a non-restricted answer 14 in that the answer is not limited to any pre-defined set of acceptable answers. That said, the non-restricted answer 14 can still be bounded in various ways without departing from the spirit and scope of the present invention. For example, the answer 14 can be bounded to 100 words, can be bounded to the topic at hand, can be bounded to non-vulgarity, etc. The answer 14 can be entered into the database 16 either verbatim or possibly with modifications as judged appropriate and/or necessary. Such answers 14 as received can be verbal, computer-input, or handwritten. Additionally, such answers 14 can be converted into a computer-recognizable text form by human or automated transcription including voice recognition or character recognition software or the like.

The database 16 having the answers 14 can be organized in any appropriate manner without departing from the spirit and scope of the present invention. For example, and as shown, the database 16 may be organized in two dimensions to include each question 12 extending in a first direction, each respondent 10 extending in a second direction orthogonal to the first direction, and each answer 14 for each question 12 for each respondent 10 residing in a cell at the intersection of the respective question 12 and respondent 10. Of course, other numbers of dimensions and other formats may also be employed as appropriate.

Notably, the textual non-restricted answers 14 for the study are by their nature richer, more personal, and more emotional as compared with restricted answers such as yes or no or multiple choice answers 14. Additionally, the textual non-restricted answers 14 are more revealing of attitudes of respondents 10 than would otherwise occur. However, and as was pointed out above, the non-restricted answers 14 are not relatively easy to aggregate, especially in any objective manner, so that quantitative analytical and statistical reports can be generated therefrom. Instead, a study evaluator heretofore performed a more qualitative evaluation of such non-restricted answers 14, which of course provided opportunity for the study evaluator to impart his or her own bias. At any rate, such an evaluation tends to be subjective, and therefore of limited use.

### Evaluation Tool

Accordingly, in various embodiments of the present invention, an evaluation tool 18 is provided to assist the study evaluator in more objectively evaluating the answers 14 of the study. As seen in FIG. 2, the evaluation tool 18 is instantiated on a computing device 20 with a display 22 and one or more input devices 24. Such computing device 20, display 22, and input devices 24 may be any appropriate respective items without departing from the spirit and scope of the present invention. For example, the computing device 20 may be a laptop computer or a desktop computer appropriately communicatively coupled to the database 16 or including such database 16, the display 22 may be a display included with or attached to the computing device 20, and the input device 24 may be a keyboard and/or a mouse included with or attached to the computing device 20. Note too that the display 22 may be a touch-screen display in which case such display 22 is also the input device 24.

The tool 18 accesses the data in the database 16 and with such data functions in the following manner. Preliminarily, it should be understood that the tool 18 includes a command input component 26, an evaluation component 28, and a display component 30. The command input component 26 of the tool 18 receives command inputs from the study evaluator or the like, and based thereon the evaluation component 28 of the tool 18 selects particular data from the database 16 and evaluates same, after which the display component 30 of the tool 18 displays at least a portion of the particular data as well as the results of the evaluation.

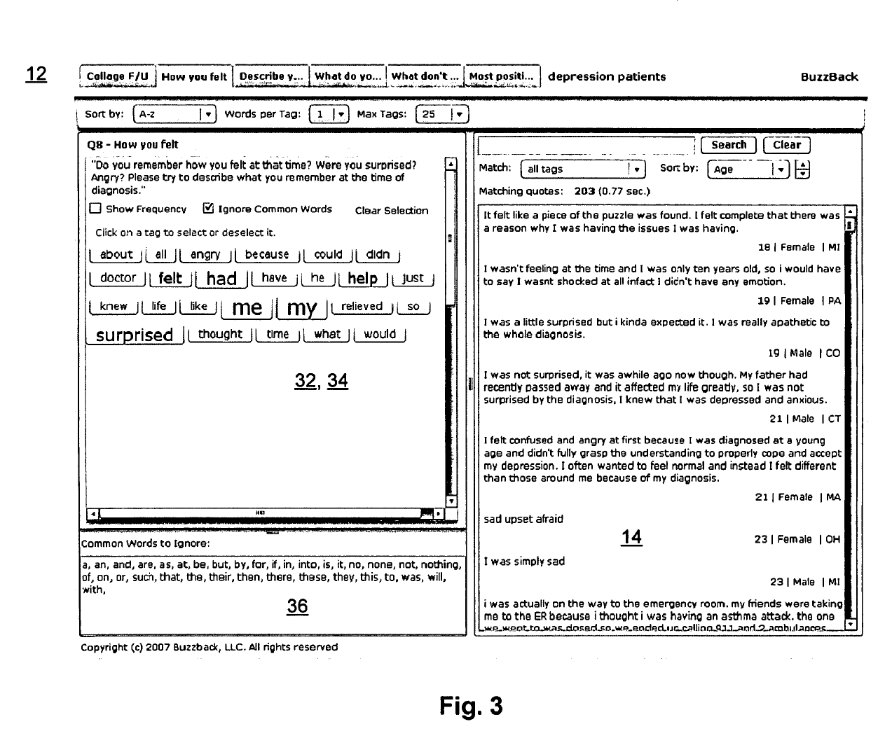

In various embodiments of the present invention, and turning now to FIG. 3, the evaluation component 22 of the tool 18 operates to among other things generate and display a keyword cloud 32 based on keywords 34 (‘tags’ in FIG. 3) appearing in the data from the database 16. As should be understood and as is shown, the keyword cloud 32 is a collection of words that appear in the data or a sub-set thereof, and especially such words that appear most frequently. Clouds 32 of tags or keywords 34 or the like are known in the prior art. For example, such clouds 32 have previously been applied to web sites and other textual and non-textual collections of data. However, such clouds 32 have not heretofore been applied to answers 14 to questions 12 in the nature of a survey or study, as is the case with the various embodiments of the present invention.

Notably, and as will be set forth in more detail below, the keyword cloud 32 is shown on the display 22 by the display component 30 of the tool 18 in such a manner that each displayed keyword 24 appears in a relative manner compared to all other displayed keywords 24. For example, a particular keyword 34 that appears in the data more frequently than another keyword 34 is represented in the cloud 32 in a more emphasized manner as compared with the another keyword 34, such as by being larger (as shown), bolder, more shaded, or differently colored. As may be appreciated, such frequency and relative emphasis is determined by the evaluation component 28 of the tool 18.

In addition and/or as an alternative to frequency, the evaluation component 28 of the tool 18 can determine or ‘weigh’ the presentation of keywords 34 in the keyword cloud 32 based on other variables. For example, keywords 34 can be graded based on some algorithm and based thereon can be displayed in a relative manner. Thus, it may be that one algorithm looks for keywords 34 relating to emotion, and based thereon determines how such emotion keywords 24 are displayed in a keyword cloud 32. Likewise, another algorithm may look for keywords 34 that are judged to be relatively positive or negative and displays such keywords 34 in the cloud 32 according to such relative positive-ness or negative-ness.

Notably, by displaying a keyword cloud 32 with keywords 34 shown in a relative manner based on the data, the tool 18 presents a powerful representation of the data that can be highly informative and that can reveal interesting and perhaps even surprising aspects of the data to a study evaluator or the like. Moreover, such a keyword cloud 32 allows the study evaluator or the like to visually assimilate how keywords 34 and phrases are used or perceived by respondents 10. Thus, what was once an overwhelming task is now more manageable in that a study evaluator can quickly and easily navigate through non-restricted answers 14 to a question 12 and find common themes across respondents 10.

In addition, and in various embodiments of the present invention, the keyword cloud 32 as displayed by the tool 18 may be interactive. As such, the study evaluator can for example select a particular keyword 34 in the cloud 32 with the input device 24 of the computing device 20, and the command input component 26 of the tool 18 can forward such selection to the evaluation component 28, which then selects data containing such selected keyword 34 for display by the display component 30 on the display 22 of the computing device 20.

### Method

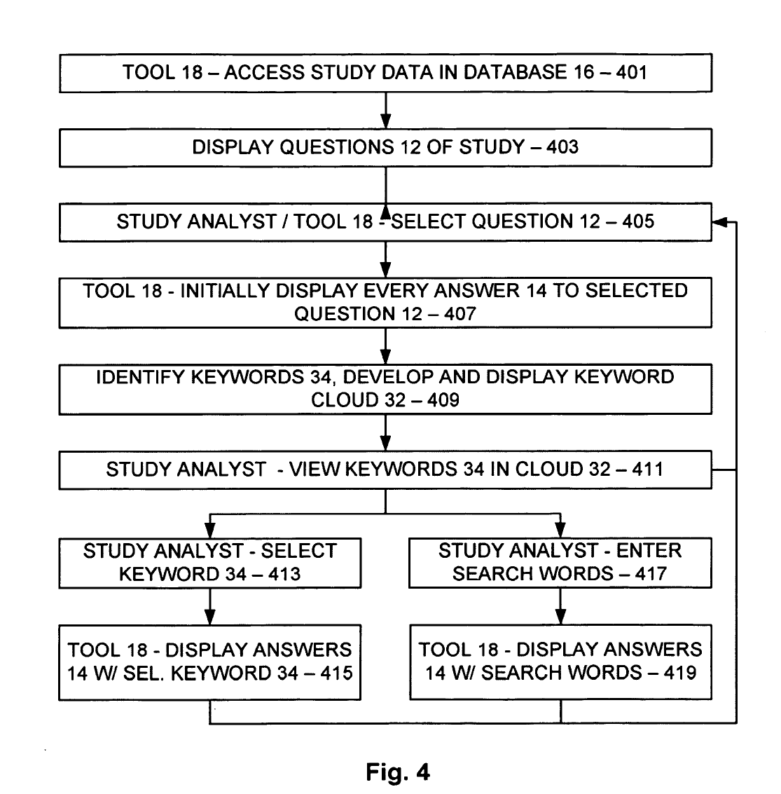

Turning now to FIG. 4, it is seen that the evaluation tool 18 operates in the following manner. Preliminarily, a study evaluator instantiates the tool 18 on the computing device 20 and in conjunction therewith identifies a study to be acted upon by the tool 18. Such identification of a study may be performed in any appropriate manner without departing from the spirit and scope of the present invention. At any rate, based on the identified study, the tool 18 accesses the corresponding data therefor in the database 16 (step 401), which as was set forth above includes a number of questions 12 asked of each respondent 10 and the corresponding answer 14 from each such respondent 10.

Thereafter, the tool 18 displays a representation of at least some of the questions 12 of the study (step 403) such that the study evaluator may select from among the displayed questions 12 for further action by the tool 18. As seen in FIG. 3, the representation of the questions 12 may be a displayed tab structure or the like on a tool screen with a portion of the text of the question 12, although other representations may of course be employed without departing from the spirit and scope of the present invention. Notably, the displayed tab structure may be scrollable if need be. With such representation of each question 12 on the tool screen, the study evaluator may select from among the questions 12 of the study, or the tool 18 may itself initially select from among the questions 12, such as for example the first question 12 (step 405).

Upon a selection of a question 12, the tool 18 proceeds by at least initially displaying on the tool screen every answer 14 to the selected question 12 from each respective respondent 10 (step 407). Similar to before, the displayed answers 14 may be scrollable if need be. In addition, the tool analyzes every answer 14 to the selected question 12 to identify keywords 34 therein, develop a corresponding keyword cloud 32 based thereon, and display on the tool screen the keyword cloud 32 for the selected question 12 (step 409), perhaps along with the full text of the selected question 12.

As shown in FIG. 3, the displayed keyword cloud 32 on the tool screen is based on a predetermined number of keywords 34 that appear most frequently in the answers 14 to the selected question 12. As also shown, each keyword 34 appears in the cloud 32 in increasing font size as the number of appearances of such keyword 32 increases. Thus, as between any two keywords 34 in the cloud 32, that which has a higher number of appearances in the answers 14 is larger. Of course, the cloud 32 may be based on factors other than number of appearance without departing from the spirit and scope of the present invention. For example, and as was set forth above, the cloud 32 may be based on a perceived positiveness or negative-ness of the answers 14, or based on emotions perceived from the answers 14.

At any rate, the study evaluator can view the keywords 34 in the displayed cloud 32 on the tool screen and particularly the relative display of each keyword 34, and based thereon can discern trends and themes based on such relatively displayed keywords 34 in such cloud 32 (step 411). To assist the study evaluator, the tool 18 allows the study evaluator to sort the keywords 34 in the displayed cloud 32 and also the answers 14 as displayed on the tool screen according to multiple sort formats. Also, the study evaluator may display for each keyword 34 in the cloud 32 the number of appearances of such keyword 34 in the answers 14, so that each keyword 34 is both visually and explicitly displayed according to the corresponding number of appearances thereof.

Notably, and regardless of the factors upon which the cloud 32 is based, the tool 18 may form the cloud 32 based on any appropriate criteria and methodology without departing from the spirit and scope of the present invention. For example, with regard to the cloud 32 shown in FIG. 3, it may be that the tool 18 first finds every word in every answer 14 and then calculates the number of appearances for each found word as the number of answers in which the found word appears. Then, the tool 18 may identify the keywords 34 as a predetermined number of the words that have the highest number of appearances, and for each identified keyword 34 calculates a font size therefor so as to correlate to the number of appearances for such identified keyword 34. Finally, the tool 18 may display each keyword 34 in the cloud 32 on the tool screen according to the font size calculated therefor.

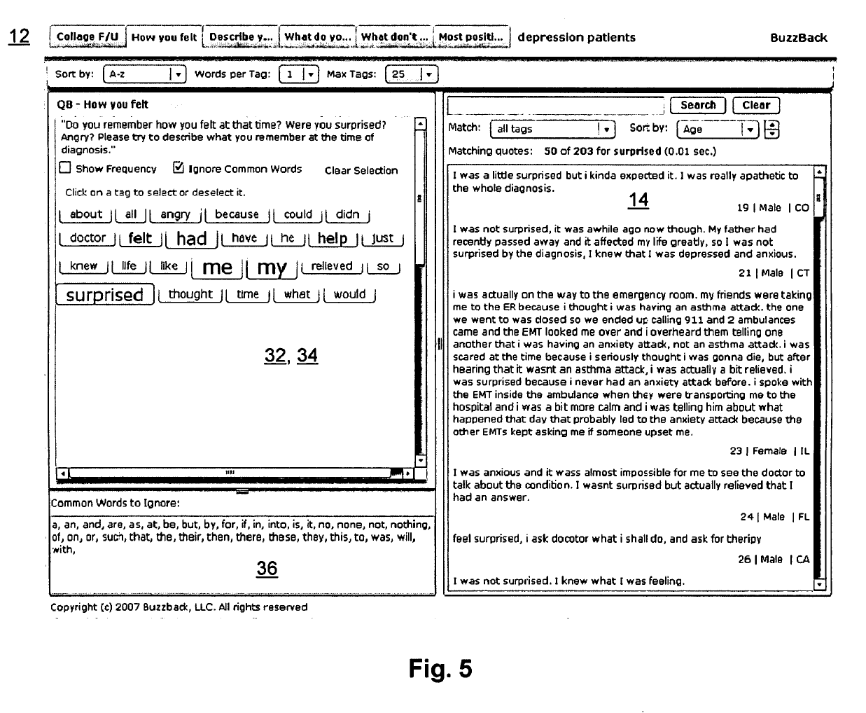

Note that upon viewing the keywords 34 in the displayed cloud 32 as at step 41 1, the study evaluator can employ the tool 18 to explore the study and the answers 14 to the question 12 selected as at step 405. For example, and as shown in FIG. 5, the study evaluator may select one of the keywords 34 in the cloud 32 by way of the input device 24 (step 413), and the tool 18 in response thereto may display on the tool screen only those answers 14 to the selected question 12 that contain such selected keyword 34 (step 415). In a similar manner, and as shown in FIG. 6, the study evaluator may select multiple ones of the keywords 34 as at step 413 and the tool 18 in response thereto may display on the tool screen only those answers 14 that contain any of the selected keywords 34, all of the selected keywords 34 (as shown), or at least a set number of the selected keywords 34 as at step 415. As should be understood, in all instances, the tool 18 may display the answers 14 in a scrollable form if need be.

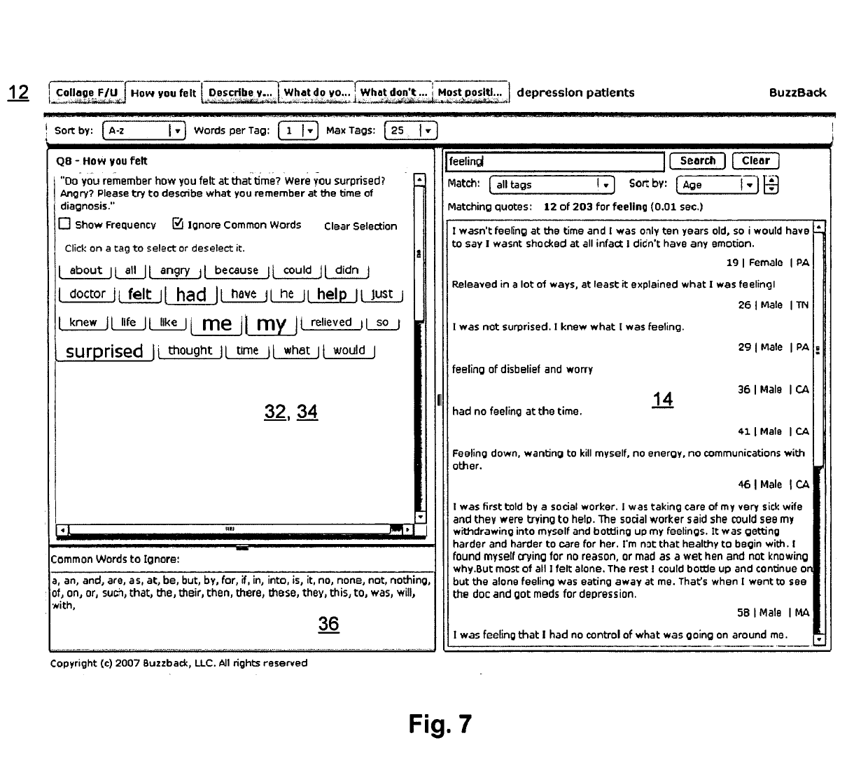

Also, the study evaluator may enter specific words into a search function on the tool screen of the tool 18 (step 417), and as is shown in FIG. 7 the tool 18 in response thereto may display on the tool screen only those answers 14 to the selected question 12 that contain the specific words searched (step 419). Note that the search function of steps 417 and 419 and the keyword selection function of steps 413 and 415 may be combined to display only those answers 14 to the selected question 12 that contain the specific words searched and also the identified keywords 34.

With regard to the keywords 34 of the cloud 32 as determined by the tool 18, it is to be appreciated that at least some words in the answers 12 are common and not especially informative, at least by themselves. Accordingly, in various embodiments of the present invention, and as is shown in FIGS. 3 and 5-7, the tool 18 allows the study evaluator to maintain a list 36 on the tool screen of common words, as is seen in FIG. 3, and to select that the tool 18 ignores such common words in the list 36 when identifying the keywords 34 as at step 409. Of course, the tool 18 in response thereto may re-perform such step 409.

Note that the study evaluator upon viewing the cloud 32 of keywords 34 on the tool screen may determine that more or less keywords 34 are needed. Accordingly, in various embodiments of the present invention, and as is shown in FIGS. 3 and 5-7, the tool 18 allows the study evaluator to select how many keywords 34 the tool 18 should display in the cloud 32. Of course, and again, the tool 18 in response thereto may re-perform such step 409.

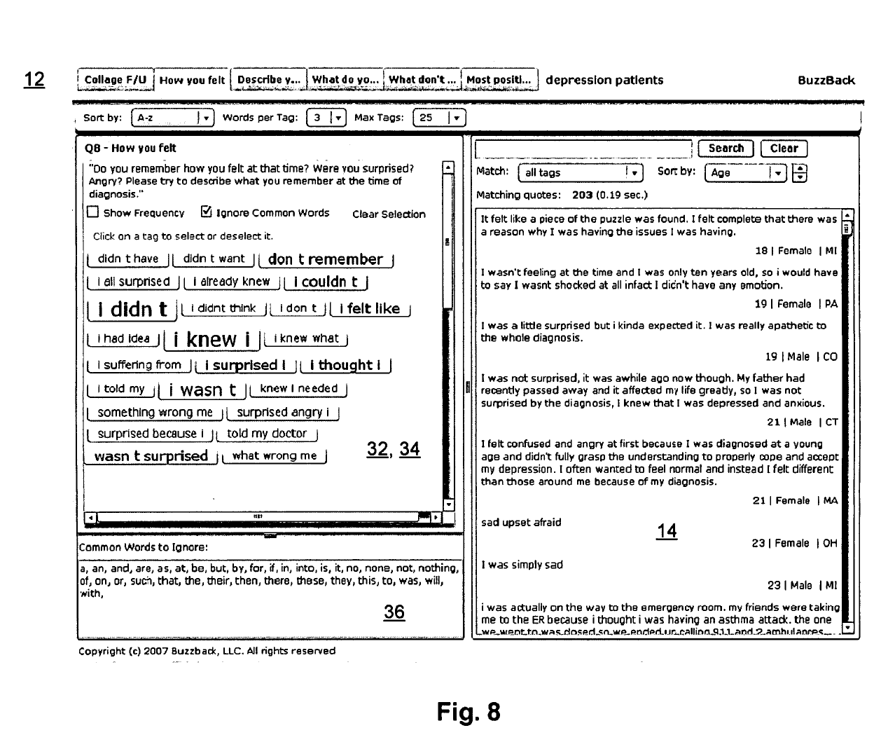

Although the various embodiments of the present invention thus far have been set forth according to keywords 18 that are single words, it is to be appreciated that such keywords 18 may instead by strings of 2, 3, 4, 5, or more words, or perhaps more appropriately keyphrases 18, as is seen in FIG. 8. Accordingly, in various embodiments of the present invention, the tool 18 allows the study evaluator to select how many words are in a keyphrase 18 (‘words per tag’ in FIG. 8), be it 1 (i.e., a keyword 18) or more Of course, and as before, the tool 18 in response thereto may re-perform such step 409 to identify keyphrases 18 having the selected number of words. Note here that if the tool 18 is set to find multi-word keyphrases 18, it may be advisable to not ignore common words. Otherwise, some of the found keyphrases 18 may seem odd. More importantly, keyphrases 18 identified to include common words may be of particular interest to the study evaluator.

As should now be appreciated, with the cloud 32 of keywords 34 or keyphrases 34 and the associated study evaluation features as provided by the tool 18, a study evaluator can review the answers 14 to a question 12 as supplied by respective respondents 10 and can find trends and other general inclinations that may be discerned from such answers 14. Thus, with the various embodiments of the present invention, the study evaluator may employ the evaluation tool 18 to more objectively evaluate non-restricted answers 14 of the study.

### Use of Tool 18 in Other Contexts

Although the evaluation tool 18 has thus far been disclosed as being employed to more objectively evaluate the answers 14 of a study, it is to be appreciated that such tool 18 may also be employed to more objectively evaluate data from most any dataset, including textual and non-textual data, without departing from the spirit and scope of the present invention. For example, such data may be textual data, audio data, video data, pictorial data, and/or the like. Moreover, such data in such dataset may be gathered in most any manner, again without departing from the spirit and scope of the present invention. In this regard, such data may be gathered as part of a study, or may be gathered by other mechanisms, including search engines, data culling tools, database aggregation tools, and/or the like.

At any rate, such data in such dataset may be operated on by the tool 18 on behalf of an evaluator or the like in a manner substantially similar to that which was set forth above with regard to a study, but with alterations as necessary depending on the nature of the specific dataset. Such alterations are believed to be apparent to the relevant public, and therefore need not be set forth herein in any detail except that which is provided.

As should be understood, and in a manner akin to that which is set forth in connection with FIG. 3, the evaluation component 22 of the tool 18 operates to among other things generate and display a visual index akin to the keyword cloud 32 based on index items that are akin to the keywords 34. Here, however, inasmuch as the dataset may be non-textual in nature, it can be the case that the index items are non-textual too. For example, if the dataset includes collections of pictorial images akin to the answers 14, the pictorial images in the collections may act as the index items, particularly if the images appear across multiple responses. Likewise, if the pictorial images are tagged with textual annotations such as attributes and corresponding values, such attributes and/or values may act as the index items.

Thus, the visual index (akin to the keyword cloud 32) is a collection of index items which are words or non-words that appear in the dataset or a sub-set thereof, and especially such index items that appear most frequently. As before, the visual index is shown on the display 22 by the display component 30 of the tool 18 in such a manner that each displayed index item appears in a relative manner compared to all other displayed index items. Again, by displaying in a relative manner, the tool 18 presents a powerful representation of the dataset that can be highly informative and that can reveal interesting and perhaps even surprising aspects of the data to a study evaluator or the like. In addition, and as before, the displayed visual index may be interactive.

In a manner akin to that which was set forth above in connection with FIG. 4, the tool 18 operates with regard to a dataset that includes a number of data collections akin to the answers 14 to a particular question 12. As such, a collection set within a particular data collection may be deemed akin to one answer 14, and a collection item within a collection set may be deemed akin to a word or phrase in an answer 14. Here, of course, a collection item may be such a word or phrase, or even a sound, a pictorial image, etc. Note, though, that such data collections in the dataset are gathered in any of a multitude of methodologies that may or may not include questions 12 and that may or may not be responsive to questions 12. For example, if the dataset is formed based on one or more search queries in connection with a search engine, the each collection may relate to a particular search query. Alternatively, the collections may be received pre-formed without regard to whatever methodology was employed to form each collection.

At any rate, after a study evaluator selects a data collection from the dataset, the tool 18 proceeds by at least initially displaying on the tool screen at least a portion of the selected data collection, and analyzes same to identify index items therein, develop a corresponding visual index based thereon, and display on the tool screen the developed visual index for the selected data collection. As before, the displayed visual index may be based on a predetermined number of index items that appear most frequently in the data collection from the dataset, and each index item may appear in the visual index in a relative manner according to such frequency. Thus, and again, the study evaluator can view the index items in the visual index on the tool screen and particularly the relative display of each index item, and based thereon can discern trends and themes based on such relatively displayed index items.

As before, the tool 18 allows the study evaluator to sort the index items in the visual index, select various ones of the index items so that only the elements of the data collection with such selected index items are displayed, perform text or non-text searching, adjust the number of index items in the visual index, and the like. Once again, with the visual index of index items and the associated study evaluation features as provided by the tool 18, a study evaluator can review the data collections in a dataset and can find trends and other general inclinations that may be discerned from such data collections. Thus, the study evaluator may employ the evaluation tool 18 to more objectively evaluate non-restricted textual and non-extual data collections of a dataset.

### Conclusion

The programming believed necessary to effectuate the processes performed in connection with the various embodiments of the present invention is relatively straight-forward and should be apparent to the relevant programming public. Accordingly, such programming is not attached hereto. Any particular programming, then, may be employed to effectuate the various embodiments of the present invention without departing from the spirit and scope thereof.

In the present invention, a computer-based evaluation tool 18 is provided for organizing and displaying non-restricted textual and also non-textual data in a dataset, such as non-restricted textual answers 14 from questions 12 presented to respondents 10 during a study interview. In particular, the evaluation tool 18 displays keywords, keyphrases, or other index items 34 culled from the answers or dataset 14 to a study evaluator in a manner that allows the evaluator to select from among displayed keywords, keyphrases, or index items 34 of interest to display corresponding answers or data 14 that reference such selected keywords, keyphrases, or index items 34. Thus, the evaluation can be performed by the evaluator in a more objective manner.

It should be appreciated that changes could be made to the embodiments described above without departing from the inventive concepts thereof. As but one example, although the various embodiments of the present invention are set forth primarily in terms of a study such as a consumer study, the study may instead be for any other type of study, and indeed may be employed to evaluate any organized set of answers 14. It should be understood, therefore, that this invention is not limited to the particular embodiments disclosed, but it is intended to cover modifications within the spirit and scope of the present invention as defined by the appended claims.

We claim:

1. A method with regard to a dataset comprising at least one data collection, each data collection comprising a plurality of collection sets, each collection set comprising a number of collection items, the method being performed by an evaluation tool instantiated on a computing device and comprising the evaluation tool:
analyzing every collection set for a particular data collection to identify index items from among the collection items therein;
developing a corresponding visual index based on the identified index items, the visual index being a visual representation of the identified index items such that each index item appears in the cloud in a relative manner based on an attribute of the index item with regard to the particular data collection; and
displaying the developed visual index,
wherein an evaluator can view the relatively appearing index items in the displayed visual index, and based thereon can discern trends in the data collection.

2. The method of claim 1 further comprising:
accessing the dataset from a database;
displaying a representation of at least some of the data collections of the dataset such that the evaluator may select from among the displayed data collections;
one of receiving from the evaluator a selection from among the data collections of the study, and initially selecting from among the data collections; and
displaying each collection set to the selected data collection.

3. The method of claim 2 wherein displaying each collection set to the selected data collection comprises displaying the collection sets in a scrollable form if need be.

4. The method of claim 1 wherein each index item is selected from among a word, a phrase, a sound, and a pictorial image.

5. The method of claim 1 wherein the developed and displayed visual index is based on a predetermined number of index items that appear most frequently in the answers to the selected question.

6. The method of claim 1 wherein each index item appears in the visual index with an increasing visual trait as a number of appearances of such index item in the data collection increases such that for any first index item having a relatively larger number of appearances in the data collection as compared with any second index item, the first index item is displayed with a larger font size as compared with the second index item.

7. The method of claim 6 wherein the visual trait is selected from a group consisting of font size, boldness, shade, and color.

8. The method of claim 1 wherein developing the index item visual index comprises:
finding every collection item in every answer;
calculating a number of appearances for each found collection item as a number of collection sets in which the found collection item appears;
identifying the index items as a predetermined number of the collection items that have the highest number of appearances; and
for each identified index item, calculating a value for a visual trait therefor to correlate to the number of appearances for such identified index item,
wherein the tool displays each index item in the visual index according to the value of the visual trait calculated therefor.

9. The method of claim 8 wherein the visual trait is selected from a group consisting of size, boldness, shade, and color.

10. The method of claim 1 further comprising receiving a selection from the evaluator of one of the index items in the visual index, and in response thereto displaying only those collection sets of the particular data collection that contain such selected index item.

11. The method of claim 1 further comprising receiving a selection from the evaluator of a plurality of the index items in the visual index, and in response thereto displaying only those collection sets of the particular data collection that contain one of: any of the selected index items, all of the selected index items, and at least a set number of the selected index items.

12. The method of claim 1 wherein identifying index items comprises ignoring common index items maintained in a common index items list.

13. The method of claim 12 further comprising receiving from the evaluator a change to the common index items list, and updating the visual index based thereon.

14. The method of claim 1 comprising displaying the developed visual index for the particular data collection with at least some of the collection sets thereof.

15. An evaluation tool with regard to a dataset comprising at least one data collection, each data collection comprising a plurality of collection sets, each collection set comprising a number of collection items, the evaluation tool being instantiated on a computing device and comprising:
a subsystem for analyzing a particular data collection to identify index items therein;
a subsystem for developing a corresponding visual index based on the identified index items of the particular data collection, the visual index being a visual representation of the identified index items such that each index item appears in the visual index in a relative manner based on an attribute of the index item with regard to the particular data collection; and
a subsystem for displaying the developed visual index for the particular data collection,
wherein an evaluator can view the relatively appearing index items in the displayed visual index, and based thereon can discern trends in the particular data collection.

16. The tool of claim 15 further comprising:
a subsystem for accessing the dataset from a database;
a subsystem for displaying a representation of at least some of the data collections of the dataset such that the evaluator may select from among the displayed data collections;
a subsystem for one of receiving from the evaluator a selection from among the data collections of the dataset, and initially selecting from among the data collections; and
a subsystem for displaying each collection set of the data collection.

17. The tool of claim 16 wherein displaying each collection set of the particular data collection comprises displaying the collection sets in a scrollable form if need be.

18. The tool of claim 15 wherein each index item is selected from among a word, a phrase, a sound, and a pictorial image.

19. The tool of claim 15 wherein the developed and displayed visual index is based on a predetermined number of index items that appear most frequently in the particular data collection.

20. The tool of claim 15 wherein each index item appears in the visual index with an increasing visual trait as a number of appearances of such index item in the particular data collection increases such that for any first index item having a relatively larger number of appearances in the data collection as compared with any second index item, the first index item is displayed with a larger size as compared with the second index item.

21. The tool of claim 20 wherein the visual trait is selected from a group consisting of size, boldness, shade, and color.

22. The tool of claim 15 wherein the subsystem that develops the index item visual index comprises:
a subsystem for finding every collection item in every collection set of the particular data collection;
a subsystem for calculating a number of appearances for each found collection item as a number of collection sets in which the found collection item appears;
a subsystem for identifying the index items as a predetermined number of the collection items that have the highest number of appearances; and
for each identified index item, a subsystem for calculating a value for a visual trait therefor to correlate to the number of appearances for such identified index item,
wherein the tool displays each index item in the visual index according to the value of the visual trait calculated therefor.

23. The tool of claim 22 wherein the visual trait is selected from a group consisting of size, boldness, shade, and color.

24. The tool of claim 15 further comprising a subsystem for receiving a selection from the evaluator of one of the index items in the visual index, and in response thereto displaying only those collection sets of the particular data collection that contain such selected index item.

25. The tool of claim 15 further comprising a subsystem for receiving a selection from the evaluator of a plurality of the index items in the visual index, and in response thereto displaying only those collection sets of the particular data collection that contain one of: any of the selected index items, all of the selected index items, and at least a set number of the selected index items.

26. The tool of claim 15 wherein the subsystem for identifying index items comprises a subsystem for ignoring common index items maintained in a common index items list.

27. The tool of claim 26 further comprising a subsystem for receiving from the evaluator a change to the common index items list, and updating the visual index based thereon.

28. The tool of claim 15 comprising a subsystem for displaying the developed visual index for the selected question with at least some of the collection sets of the particular data collection.
